(19) United States
(12) Patent Application Publication
(10) Pub. No.: US 2023/0018627 A1
(43) Pub. Date: Jan. 19, 2023

(54) Track Caliper

(71) Applicant: Shaoming Bu, Guilin (CN)

(72) Inventor: Shaoming Bu, Guilin (CN)

(21) Appl. No.: 17/305,815

(22) Filed: Jul. 14, 2021

(51) Int. Cl. E01B 35/06; G01B 3/38

(52) U.S. Cl. CPC E01B 35/06; G01B 3/38; E01B 2203/16

(57) ABSTRACT

This invention discloses a track caliper that can measure vertical and horizontal wearing of different track types. It includes a caliper bar and a big slider that can move along the caliper bar. A small slider, with a right-angle bayonet on its right, can move along the caliper bar jaw to set the desired measuring position. A positioning plate, articulated with a rotary arm, installs on the big slider jaw and has a structure to limit the rotary arm in the vertical direction. A crossing-groove block is slide-mounted on the rotary arm, a horizontal bar is slide-mounted on the crossing-groove block and can move perpendicular with the rotary arm. When the front measuring surface on the horizontal bar aligns with the measuring surface of the probe on the big slider jaw, the marking on the horizontal bar aligns with the “0” line on the crossing-groove block.

### BACKGROUND OF THE INVENTION

During the dimension control of track maintenance, it is mandatory to measure the track heads' vertical and horizontal wearing for different types of tracks, whose heads have different dimensions and shapes. If maintenance personnel want to measure different types of track heads' vertical and horizontal wearing, they must equip different measuring devices just because the types of track heads' dimensions and shapes are different.

Additionally, most track heads' vertical and horizontal wearing measuring devices must be calibrated and zeroed first at the maintenance sites by standard masters before measuring, which brings the operational difficulty and increases the accuracy uncertainty. However, during the period of the rail building process, different types of tracks must be used according to different purposes. For example, the subway system uses one type of track, the heavy cargo trains use their types of tracks, and the passenger trains use other types of tracks.

As a result of the above, railway companies must equip different measuring devices and standard masters to measure the wearing of different types of track heads, which tremendously increases the purchase and management costs. At the same time, the track maintenance workers must take different but similar measurement devices for measuring different types of track heads' vertical and horizontal wearing when they do the maintenance service, which is not adapted for efficient track transportation development.

### SUMMARY OF THE INVENTION

To resolve the limit of existing technology, this invention introduces a Track Caliper that can measure different types of track heads' vertical and horizontal wearing by one product, which includes the Caliper Bar, the Big Slider that can move forward and backward along the Caliper Bar, a pair of probes on the Big Slider Jaw and the Caliper Bar Jaw are opposite with each other. When the distance between the Probe on the Bar Jaw and the Probe on the Big Slider Jaw is zero, the “0” line in the Caliper Bar graduation markings aligns with the “0” line in the Vernier graduation markings, or the digital display on the screen is zero for the electronic digital caliper.

Comparing with regular caliper, the differences are as following:

1. On the Caliper Bar Jaw, there is a Small Slider that can move upward and downward along the Caliper Bar Jaw to adapt vertical wearing measurements on different types of track heads. On the right side of the Small Slider, there is a right-angle bayonet composed of a Vertical Surface and a Horizontal Surface, the Vertical Surface of the Bayonet aligns with the measuring surface of the Probe on the Bar Jaw, the Horizontal Surface of the Bayonet is vertical with the measuring surface of the Probe on the Bar Jaw.

2. On the upper-right corner of the Big Slider Jaw, there is a Positioning Plate, which has two holes, one is a Working Hole and the other one is a Non-Working Hole. A Rotary Arm is articulated with the Positioning Plate at the rear. The Rotary Arm can rotate against the articulation point between the Working Hole and the Non-Working Hole. A Crossing-Groove Block is slide-mounted on the Rotary Arm and can move upward and downward along the Rotary Arm. A Horizontal Bar is slide-mounted on the Crossing-Groove Block and can move forward and backward inside the groove of the Crossing-Groove Block in the direction that is perpendicular to the Rotary Arm.

On the front part of the Horizontal Bar, there is a right-angle probe composed of a Front Measuring Surface and a Bottom Measuring Surface. When the Front Measuring Surface of the Horizontal Bar aligns with the measuring surface of the Probe on the Big Slider Jaw, the Marking on the Horizontal Bar aligns with the “0” line in the Graduation Markings on the Crossing-Groove Block.

3. Between the Caliper Bar and the Big Slider, between the Caliper Bar Jaw and the

Small Slider, between the Positioning Plate and the Rotary Arm, between the Crossing-Groove Block and the Rotary Arm, between the Horizontal Bar and the Crossing-Groove Block, there are locking devices that can lock their positions.

4. The Caliper Bar Jaw has one or more markings on the surface, each marking represents the track-head-vertical-wearing-measuring position of a track type. Among all these markings on the Caliper Bar Jaw, the top first marking represents the heaviest track head-vertical-wearing-measuring position, the bottom last marking represents the lightest track head-vertical-wearing-measuring position.

5. A Positioning Pin installs on the Rotary Arm. When the Rotary Arm rotates to the Working Hole on the Positioning Plate, the Positioning Pin will slip into the Working Hole, and the Rotary Arm will stay in the working position. When the Rotary Arm rotates to the Non-Working Hole, the Positioning Pin will slip into the Non-Working Hole. Between the Positioning Plate and the Rotary Arm, there is a locking device to lock the position of the Rotary Arm.

### BRIEF DESCRIPTION OF THE DRAWINGS

In the drawings, which form a part of the specifications:

Fig. #1 is the front view of this invention;

Fig. #2 is the rear view of this invention;

Fig. #3 is the implementation for measuring the vertical wearing of 132RE track head;

Fig. #4 is the implementation for measuring the horizontal wearing of a track head;

Fig. #5 is the implementation for measuring the height difference between a sharp track head and a bordering 132RE track head at a Switch.

Number identification inside drawings:

1. Caliper Bar, 2. Big Slider, 3. Small Slider, 4. Positioning Plate, 5. Rotary Arm, 6. Crossing-Groove Block, 7. Horizontal Bar, 8. Vernier, 9. Limit Pin, 1-1. Caliper Bar jaw, 1-2. Probe on the Bar Jaw, 2-1. Big Slider Jaw, 2-2. Probe on the Big Slider Jaw, 3-1. Vertical Surface of the Bayonet, 3-2. Horizontal Surface of the Bayonet, 4-1. Working Hole, 4-2. Non-Working Hole, 5-1. Positioning Pin, 6-1. Graduation Markings on the Crossing-Groove Block, 7-1. Marking on the Horizontal Bar, 7-2. Front Measuring Surface of the Horizontal Bar, 7-3. Bottom Measuring Surface of the Horizontal Bar

### DETAILED DESCRIPTION OF THE INVENTION

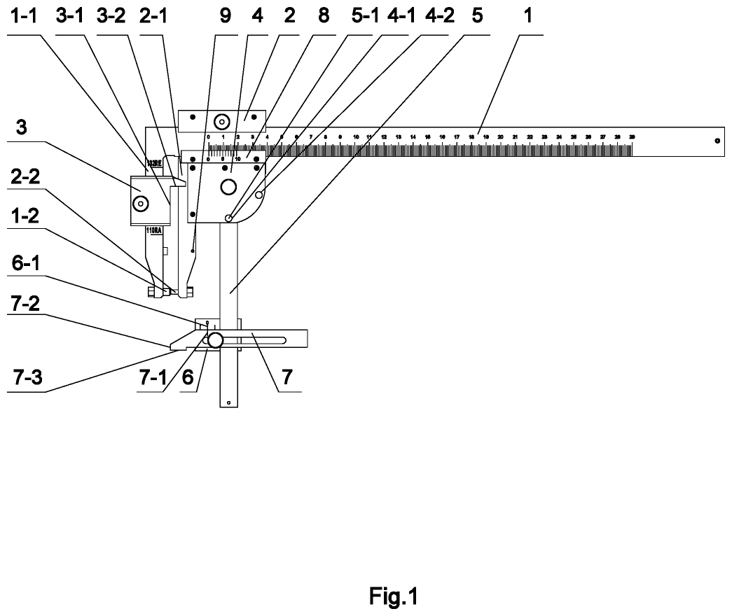

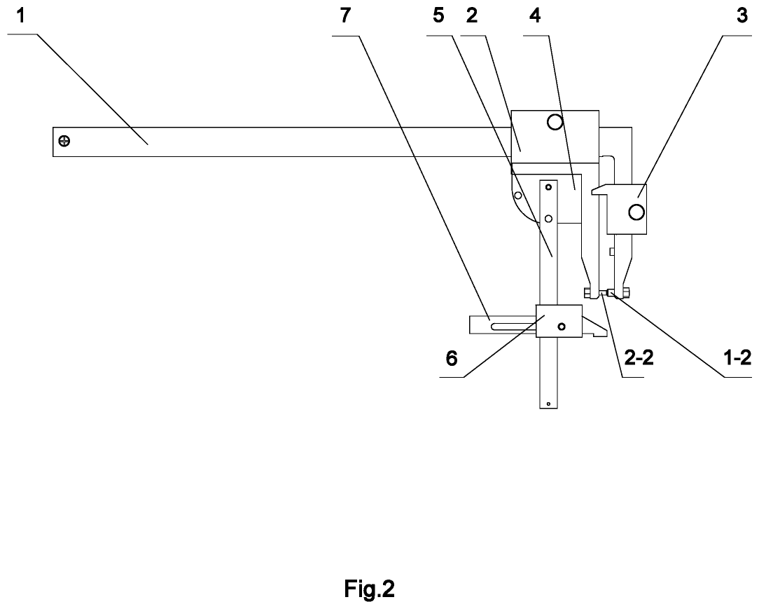

This invention, the Track Caliper, which includes the Caliper Bar (1) and the Big Slider (2), the Big Slider (2) is slide-mounted on the Caliper Bar (1) and the Big Slider (2) can move forward and backward along the Caliper Bar (1); the Probe on the Bar Jaw (1-2) installs at the bottom of the Caliper Bar Jaw (1-1), and it faces backward; the Probe on the Big Slider Jaw (2-2) installs at the bottom of the Big Slider Jaw (2-1), it faces forward and is opposite to the Probe on the Bar Jaw (1-2); When the Big Slider (2) can not move forward further along the Caliper Bar (1), the distance between the Probe on the Bar Jaw (1-2) and the Probe on the Big Slider Jaw (2-2) is zero (the measuring surfaces of two probes contact with each other), the “0” line in the Caliper Bar (1) graduation markings and the “0” line in the Vernier (8) graduation markings will align with each other; the Big Slider (2) can be stopped and kept staying on the Caliper Bar (1) by a limit screw at the end of the Caliper Bar (1) when it moves backward; as shown in FIG. 1 and FIG. 2.

There are many markings on the Caliper Bar Jaw (1-1) from top to down, each marking represents the measuring position of the vertical wearing for a type of track head, as shown in FIG. 1.

The Small Slider (3) is slide-mounted on the Caliper Bar Jaw (1-1), which can move upward and downward to adapt vertical wearing measurements on different track types; there is a right-angle bayonet composed of a Vertical Surface (3-1) and a Horizontal Surface (3-2) on the right side of the Small Slider (3), the Vertical Surface of the Bayonet (3-1) aligns with the measuring surface of the Probe on the Bar Jaw (1-2), the Horizontal Surface of the Bayonet (3-2) is vertical with the measuring surface of the Probe on the Bar Jaw (1-2), the right-end of the Horizontal Surface of the Bayonet (3-2) passes the measuring surface of the Probe on the Bar Jaw (1-2); as shown in FIG. 1 and FIG. 2.

The Positioning Plate (4) installs on the upper-right corner of the Big Slider Jaw (2-1) and attaches on the lower part of the Big Slider (2); there are two holes on the Positioning Plate (4), one is the Working Hole (4-1) and the other one is the Non-Working Hole (4-2); the upper side of the Rotary Arm (5) is articulated at the rear of the Positioning Plate (4), the Rotary Arm (5) can rotate against the articulation point; the Positioning Pin (5-1) installs on the upper side of the Rotary Arm (5) and below the articulation point; when the Rotary Arm (5) rotates towards the Working Hole (4-1), the Positioning Pin (5-1) will slip into the Working Hole (4-1), then the Rotary Arm (5) can not rotate further, and stays vertically; the Crossing-Groove Block (6) is slide-mounted on the Rotary Am (5) and can move upward and downward along the Rotary Arm (5); the Horizontal Bar (7) is slide-mounted on the Crossing-Groove Block (6) and can move forward and backward inside the groove of the Crossing-Groove Block (6) in the direction that is perpendicular to the Rotary Arm (5); on the front part of the Horizontal Bar (7), there is a right-angle probe composed of a Front Measuring Surface (7-2) and a Bottom Measuring Surface (7-3), when the Front Measuring Surface (7-2) aligns with the measuring surface of the Probe on the Big Slider Jaw (2-2), the Marking on the Horizontal Bar (7-1) aligns with the “0” line in the Graduation Markings on the Crossing-Groove Block (6-1); as shown in FIG. 1 and FIG. 2.

Between the Caliper Bar (1) and the Big Slider (2), between the Caliper Bar Jaw (1-1) and the Small Slider (3), between the Positioning Plate (4) and the Rotary Arm (5), between the Crossing-Groove Block (6) and the Rotary Arm (5), between the Horizontal Bar (7) and the Crossing-Groove Block (6), there are locking devices, these locking devices can lock the Big Slider (2), the Small Slider (3), the Rotary Arm (5), the Crossing-Groove Block (6), and the Horizontal Bar (7) when they are in desire positions, as shown in FIG. 1 and FIG. 2.

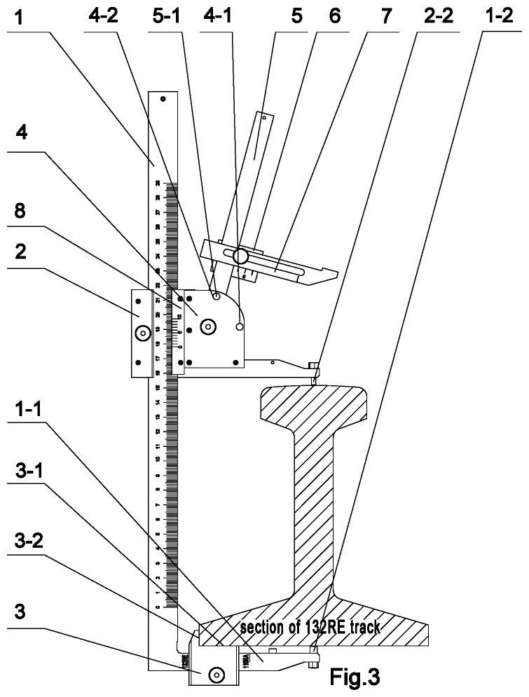

As shown in FIG. 3, which uses the invention to measure the vertical wearing for 132RE track head:

1. Adjust the position of the Small Slider (3), let the top edge of the Small Slider (3) overlap the 132RE marking on the Caliper Bar Jaw (1-1), and then lock the Small Slider (3). At this moment, the vertical distance between the Horizontal Surface of the Bayonet (3-2) and the centerline of the Probe on the Bar Jaw (1-2) meets the regulated requirements of the vertical-wearing-measuring position for the 132RE track.

2. Rotate the Rotary Arm (5) to the Non-Working Hole (4-2), lock the Rotary Arm (5) after the Positioning Pin (5-1) on the Rotary Arm (5) slips into the Non-Working Hole (4-2), which makes sure it does not interfere with the present measurement.

3. Move the Big Slider (2) backward and let the distance between the measuring surface of the Probe on the Bar Jaw (1-2) and the measuring surface of the Probe on the Big Slider Jaw (2-2) to be bigger than the height of 132RE track.

4. Make the Vertical Surface of the Bayonet (3-1) on the Small Slider (3) contacting with the 132RE track bottom, and make the measuring surface of the Probe on the Bar Jaw (1-2) contacting with the bottom of 132RE track, and make the Horizontal Surface of the Bayonet (3-2) on the Small Slider (3) contacting with the 132RE track bottom edge at the same time.

5. Keep the Caliper steady, then move the Big Slider (2) forward, let the measuring surface of the Probe on the Big Slider Jaw (2-2) contact with the top of 132RE track.

6. Lock the Big Slider (2), take the caliper out from the track, record the measuring value of the caliper by reading the graduation markings on the Caliper Bar (1) and the graduation markings on the Vernier (8), this measuring value of the caliper is the height of 132RE track.

7. Compare the measuring value of the 132RE track height obtained from the above operation with the nominal height of 132RE track, then the difference is the vertical wearing value of 132RE track.

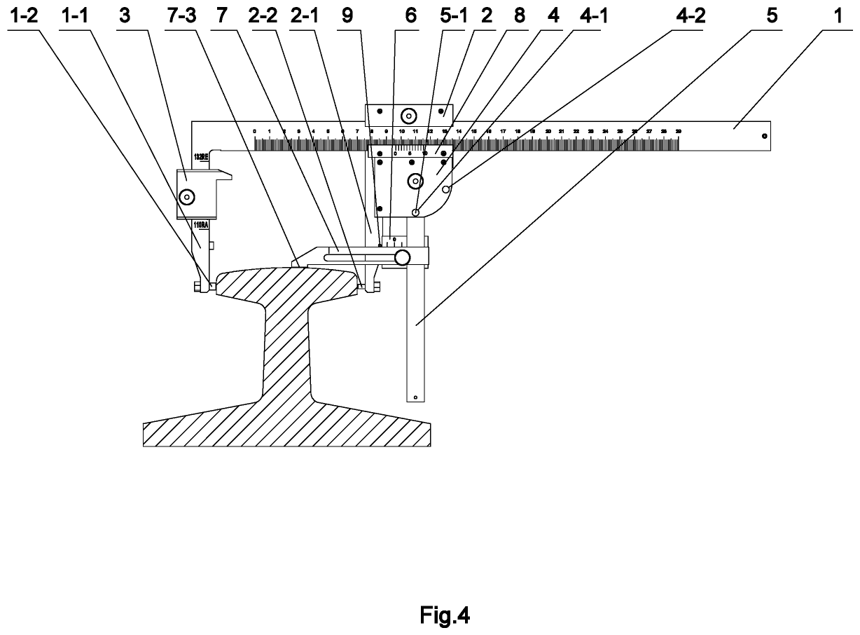

As shown in FIG. 4, which uses this invention to measure the horizontal wearing for a track head:

1. Move the Small Slider (3) to any position along the Caliper Bar Jaw (1-1), the final position of the Small Slider (3) is not relevant to the markings on the Caliper Bar Jaw (1-1) for this measurement.

2. Rotate the Rotary Arm (5) and let the Positioning Pin (5-1) slip into the Working

Hole (4-1), lock the Rotary Arm (5).

3. Move the Crossing-Groove Block (6) upward till the Horizontal Bar (7) is stopped by the Limit Pin (9) on the Big Slider Jaw (2-1), move the Horizontal Bar (7) to left till it can not move further, and lock the Crossing-Groove Block (6) and the Horizontal Bar (7). At this moment, the vertical distance between the Bottom Measuring Surface of the Horizontal Bar (7-3) and the centerline of the Probe on the Big Slider Jaw (2-2) meets the regulated requirements of the horizontal-wearing-measuring position for the track.

4. Move the Big Slider (2) backward and let the distance between the measuring surface of the Probe on the Bar Jaw (1-2) and the measuring surface of the Probe on the Big Slider Jaw (2-2) to be bigger than the width of the track head.

5. Keep the Bottom Measuring Surface of the Horizontal Bar (7-3) staying on the top of the track head.

6. Move the Big Slider (2) forward and let the measuring surface of the Probe on the Caliper Bar Jaw (1-2) and the measuring surface of the Probe on the Big Slider Jaw (2-2) contact with both sides of the track head respectively, lock the Big Slider (2).

7. Take the caliper out from the track, record the measuring value of the caliper by reading the graduation markings on the Caliper Bar (1) and the graduation markings on the Vernier (8), this measuring value of the caliper is the width of the track head.

8. Compare the measuring value of the track width obtained from the above operation with the nominal width of the track, then the difference is the horizontal wearing value of the track head.

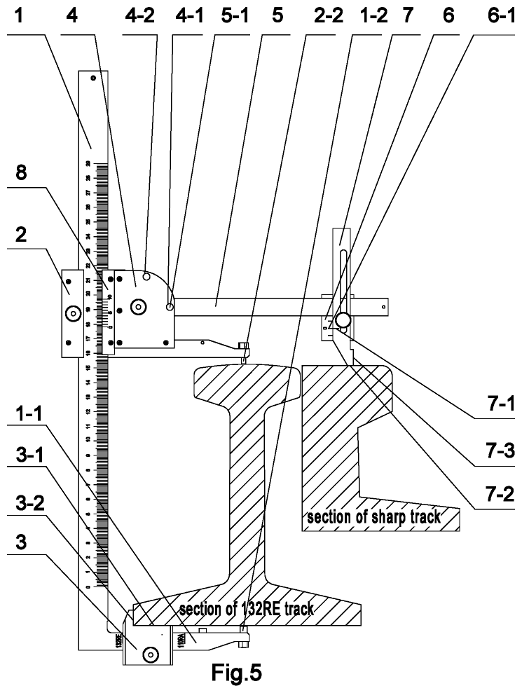

As shown in FIG. 5, which uses this invention to measure the height difference of a sharp track comparing with the bordering 132RE track at a switch:

1. Adjust the position of the Small Slider (3), let the top edge of the Small Slider (3) overlap the 132RE marking on the Caliper Bar Jaw (1-1), and lock the Small Slider (3). At this moment, the vertical distance between the Horizontal Surface of the Bayonet (3-2) and the centerline of the Probe on the Bar Jaw (1-2) meets the regulated requirements of the vertical-wearing-measuring position for 132RE track.

2. Rotate the Rotary Arm (5) and let the Positioning Pin (5-1) slip into the Working Hole (4-1), lock the Rotary Arm (5).

3. Move the Big Slider (2) backward and let the distance between the measuring surface of the Probe on the Bar Jaw (1-2) and the measuring surface of the Probe on the Big Slider Jaw (2-2) to be bigger than 132RE track height.

4. Make the Vertical Surface of the Bayonet (3-1) on the Small Slider (3) contacting with the 132RE track bottom, and make the measuring surface of the Probe on the Bar Jaw (1-2) contacting with the 132RE track bottom, and make the Horizontal Surface of the Bayonet (3-2) on the Small Slider (3) contacting with the 132RE track bottom edge at the same time.

5. Keep the Caliper steady, move the Big Slider (2) forward, and let the measuring surface of the Probe on the Big Slider Jaw (2-2) contact with the top of the 132RE track head.

6. Lock the Big Slider (2), move the Crossing-Groove Block (6) downward, let the

Front Measuring Surface of the Horizontal Bar (7-2) contact with the sharp track head top.

7. Lock the Crossing-Groove Block (6) and the Horizontal Bar (7), take the caliper out from the track.

8. Record the measuring value by reading the Graduation Markings on the

Crossing-Groove Block (6-1) and the Marking on the Horizontal Bar (7-1), the measuring value is the height difference between the sharp track and the bordering 132RE track.

What is claimed is:

1. A Track Caliper includes a Caliper Bar (1) and a Big Slider (2) that is slide-mounted on the Caliper Bar (1), the Big Slider (2) can move forward and backward along the Caliper Bar (1); a Probe on a Bar Jaw (1-2) installs at the bottom of a Caliper Bar Jaw (1-1) and facing backward; a Probe on a Big Slider Jaw (2-2) installs at the bottom of a Big Slider Jaw (2-1) and facing forward; when the distance between the Probe on the Bar Jaw (1-2) and the Probe on the Big Slider Jaw (2-2) is zero, the “0” line in the Caliper Bar (1) graduation markings and the “0” line in a Vernier (8) graduation markings will align with each other, or the digital displaying on the screen is “0” for an electronic digital caliper.
On the Caliper Bar Jaw (1-1), there is a Small Slider (3) that can move upward and downward along the Caliper Bar Jaw (1-1) to adapt vertical wearing measurements on different types of track heads; on the right side of the Small Slider (3), there is a right-angle bayonet composed of a Vertical Surface (3-1) and a Horizontal Surface (3-2), the Vertical Surface of the Bayonet (3-1) aligns with the measuring surface of the Probe on the Bar Jaw (1-2), the Horizontal Surface of the Bayonet (3-2) is vertical with the measuring surface of the Probe on the Bar Jaw (1-2).
On the upper-right corner of the Big Slider Jaw (2-1), there is a Positioning Plate (4) that has two holes, one is a Working Hole (4-1) and the other is a Non-Working Hole (4-2); a Rotary Arm (5) is articulated at the rear of the Positioning Plate (4), the Rotary Arm (5) can rotate between the Working Hole (4-1) and the Non-Working Hole (4-2) against the articulation point; a Crossing-Groove Block (6) is slide-mounted on the Rotary Arm (5) and it can move upward & downward along the Rotary Arm (5); a Horizontal Bar (7) is slide-mounted on the Crossing-Groove Block (6) and it can move forward & backward inside the groove of the Crossing-Groove Block (6) in the direction that is perpendicular with the Rotary Arm (5); on the front part of the Horizontal Bar (7), there is a right-angle probe composed of a Front Measuring Surface (7-2) and a Bottom Measuring Surface (7-3); when the Front Measuring Surface (7-2) of the Horizontal Bar (7) aligns with the measuring surface of the Probe on the Big Slider Jaw (2-2), a Marking on the Horizontal Bar (7-1) aligns with the “0” line in Graduation Markings on the Crossing-Groove Block (6-1).
Between the Caliper Bar (1) and the Big Slider (2), between the Caliper Bar Jaw (1-1) and the Small Slider (3), between the Positioning Plate (4) and the Rotary Arm (5), between the Crossing-Groove Block (6) and the Rotary Arm (5), between the Horizontal Bar (7) and the Crossing-Groove Block (6), there are locking devices that can lock the Big Slider (2), the Small Slider (3), the Rotary Arm (5), the Crossing-Groove Block (6) and the Horizontal Bar (7) when they are at a desire position.

2. The Track Caliper has the characteristics as: the Caliper Bar Jaw (1-1) has one or more positioning indicators on the surface, each positioning indicator represents the track-head-vertical-wearing-measuring position of one track's type.

3. The Track Caliper according to claim 2, wherein the positioning indicators are markings, inside all these markings on the Caliper Bar Jaw (1-1), the top first marking represents the heaviest track head-vertical-wearing-measuring position, the bottom last marking represents the lightest track head-vertical-wearing-measuring position.

4. The Track Caliper according to claim 1, wherein there is a limit structure, between the Big Slider Jaw (2-1) and the Horizontal Bar (7), or between the Rotary Arm (5) and the Crossing-Groove Block (6), to limit the position(s) of the Horizontal Bar (7) when it moves upward.

5. The Track Caliper according to claim 4, wherein the limit structure is a Limit Pin (9) or a device on the Big Slider Jaw (2-1), or the limit structure has positioning indicator(s) on the Rotary Arm (5).

6. The Track Caliper according to claim 1, wherein the bayonet on the Small Slider (3) is a right-angle bayonet set up on the Caliper Bar Jaw (1-1).

7. The Track Caliper according to claim 1, wherein the Vertical Surface of the Bayonet (3-1) on the Small Slider (3) aligns with the measuring surface of the Probe on the Caliper Bar Jaw (1-2).

8. The Track Caliper according to claim 1, wherein the Rotary Arm (5) is articulated with the Positioning Plate (4), there is a structure on the Positioning Plate (4) or the Rotary Arm (5) to limit the Rotary Arm (5) in the vertical position, there is a locking device to lock the Rotary Arm (5) between the Positioning Plate (4) and the Rotary Arm (5).
